(19) United States
(12) Patent Application Publication
(10) Pub. No.: US 2008/0141542 A1
(43) Pub. Date: Jun. 19, 2008

(54) Electric Mowing Machine

(76) Inventor: Te-Hua Hung, Fenyuan Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/953,980

(22) Filed: Dec. 11, 2007

(30) Foreign Application Priority Data
Dec. 14, 2006 (TW) 95146929

(51) Int. Cl. A01D 34/416; A01D 69/02

(52) U.S. Cl. 30/277.4; 56/11.9

(57) ABSTRACT

An electric mowing machine includes a stem, a power supply disposed on the stem, a motor base that is installed to the stem receiving a motor which electrically communicates with the power supply and includes a shaft disposed through the motor. A cutter installed on the shaft of the motor rotatably, and a motor secure device mounted between the cutter and the shaft of the motor and adapted for prevent the shaft of the motor from bearing external force.

### BACKGROUND OF THE INVENTION

1. Field of the Invention

The present invention relates to an electric mowing machine. In particular, the electric mowing machine has a motor secure device

2. Description of the Related Art

A conventional electric mowing machine is improved for problems of noise abatement and exhaust fume from engine driven type lawnmower, as shown in reference JP Utility Model Patent NO 7-5321. Meanwhile, the mower 1 in reference solves the problem of quake while using the engine driven type lawnmower for a convenience use. However, whether a cutter is made from metal blade or nylon rope, the main shaft of motor SA of the mower 1 is easy to contact with rocks or ridge things on the lawn during mowing, because there is no device for securing the motor 5A. So that it increase load of the motor 5A as to reduce the use-life. Furthermore, the cutter 6 of the mower 1 is preferably in a form of nylon rope, hence in use a user has to beat the button on the mowing portion 7 (not shown) for pulling the nylon rope 6 so that the beating force will transmit to the main shaft of the motor 5A. And it also reduces the use-life of the mower 1.

The present invention is therefore intended to obviate or at least alleviate the problems encountered in prior art.

### SUMMARY OF THE INVENTION

The present invention solves this need and other problems in the field of electric mowing machine with motor secure device by providing, in a preferred form, an electric mowing machine including a stem, a power supply installed to an end of the stem, a motor base installed to another end of the stem and received a motor. The motor electrically communicates with the power supply, and a motor disposes a shaft therethrough. A cutter is installed to the shaft of the motor rotatably. A motor secure device is provided between the cutter and the shaft of the motor and adapted for bearing the external force of beating the cutter or preventing the motor or preventing the motor from quaking in use. The shaft of the motor does not directly bear force, so that it can reduce wear of the motor and protect the motor from being broken easily.

Other advantages, objectives and features of the present invention will become apparent from the following description referring to the attached drawings.

### BRIEF DESCRIPTION OF THE DRAWINGS

FIG. 1 is a perspective view of an electric mowing machine in accordance with the first embodiment of the present invention.

FIG. 2 is a perspective view of a motor base in accordance with the first embodiment of the present invention.

FIG. 3 is an exploded view in FIG. 2.

FIG. 4 is a sectional view taken along plane 4-4 in FIG. 2.

FIG. 5 is a section view similar to FIG. 4, illustrating the shaft of the motor bearing the external force form the cutter.

FIG. 6 is a perspective view of an electric mowing machine in accordance with the second embodiment of the present invention.

### DETAILED DESCRIPTION OF THE PREFERRED EMBODIMENTS

The detailed description and technical characteristics of the present invention and described together with the drawings as follows.

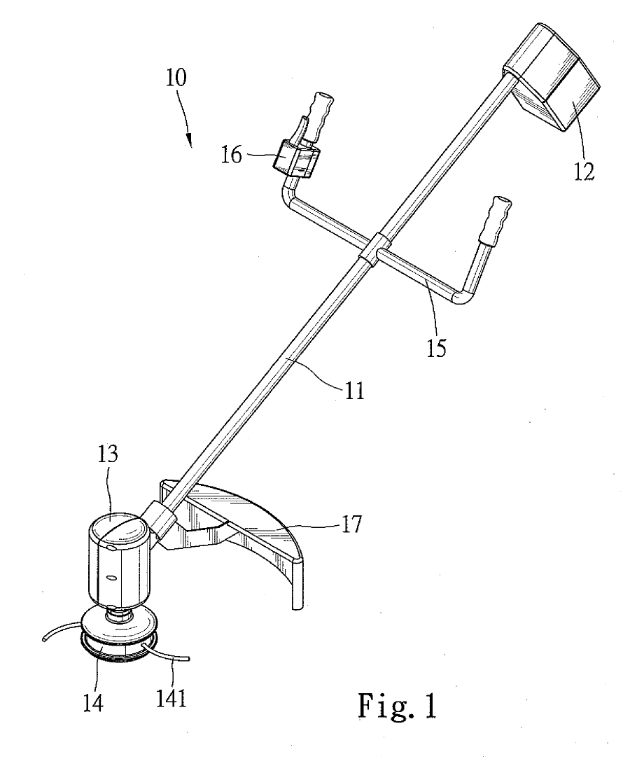

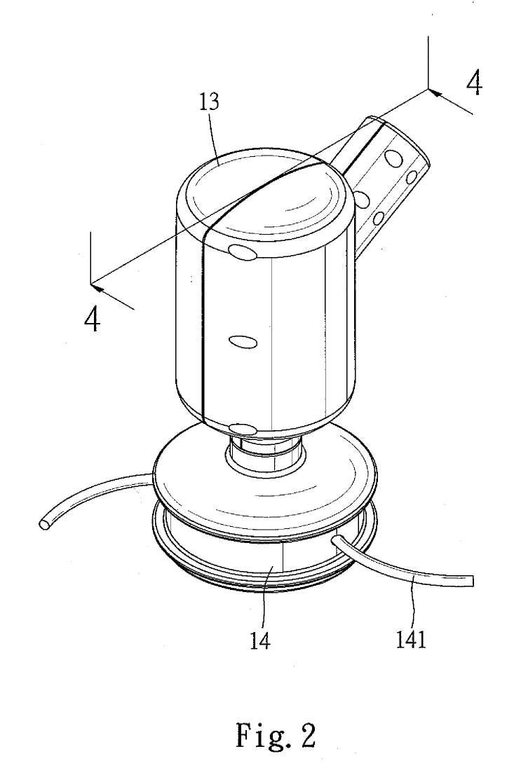

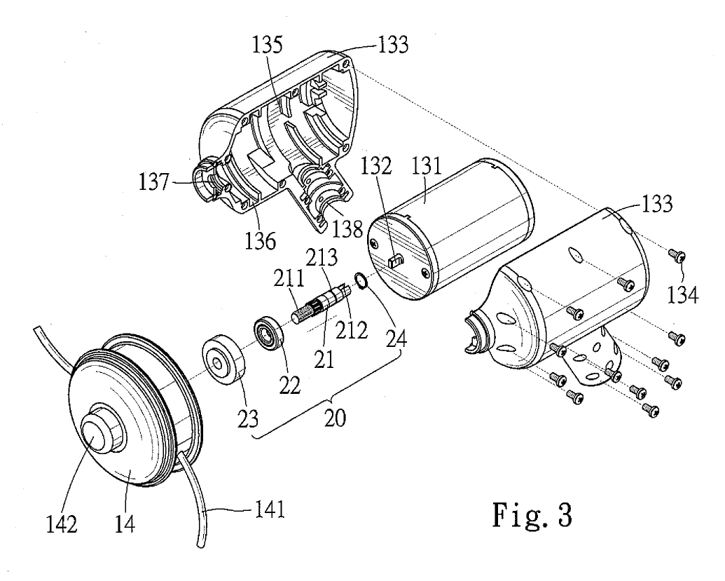

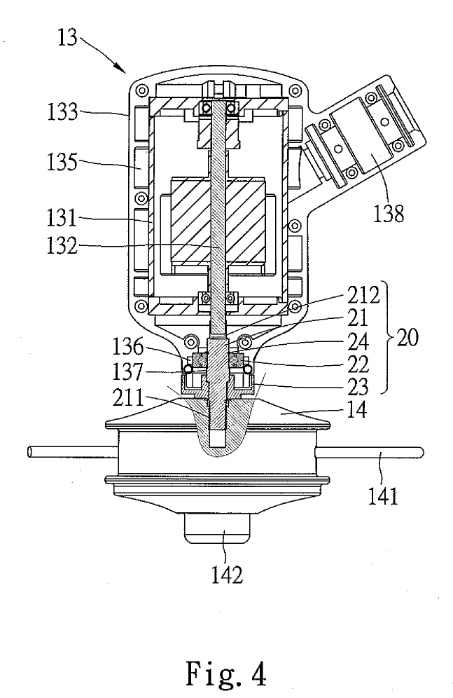

Referring to FIGS. 1 to 4, an electric mowing machine 10 in accordance with a first embodiment in the present invention includes a stem 11, a power supply 12 installed to an end of the stem 11, a motor base 13 installed to another end of the stem 11 and provided for a cutter 14 coupling thereto rotatably. A nylon rope 141 is received in the interior of the cutter 14, and two ends of the nylon rope 141 respectively insert through the periphery of the cutter 14 so that a user can pull the rope 141 outwardly for mowing. In this embodiment, there is a 24V/DC battery set in the power supply 12. The mowing machine 10 further includes a handle bar 15 installed on the stem 11, a power switch 16 which is disposed on the handle bar 15 and electrically communicates the power supply 12 to a motor 131 in the motor base 13, and a shield 17 provided adjacent to a side of the motor base 13 and the stem 11 and adapted for keeping the mowed grass off the user.

The motor base 13 consists of two halves 133 and a plurality of engaging elements 134 for fixing the halves 133 to one another, with each half 133 complementarily receiving another half 133. The motor base 13 includes a first end defined a coupled portion 138 for inserted the stem 11, a second end forming a through hole 137 in communication with the interior thereof, a compartment 135 defined therein, and a fixed portion 136 formed between the through hole 137 and compartment 135.

The motor 131 is disposed in the compartment 135 of the motor base 13 and adapted for a shaft 132 installed therethrough longitudinally. In the preferred form, the profile of the distal end of the shaft 132 which protrudes from the motor is non-circular.

A motor secure device 20 is installed to the end of the shaft 132. The function of the motor secure device 20 is transmitting the power from the motor 131 to the cutter 14 and preventing the external force from affecting the shaft 132 of the motor 131 as to lengthen use-life and improve efficiency of the motor 131.

The motor secure device 20 includes an axle 21 having a first end and a second end, a bearing 22 disposed on the axle 21 and received in the fixed portion 136, a cap 23, which is disposed on the first end of the axle 21 and mounted on the second end of the motor base 13 adjacent to the through hole 137, and a clip 24 installed on the second end of the axle 21. The cap 23 can prevent dirt and the like from getting into the motor base 13. In the preferred form, the clip is C-shaped.

The axle 21 includes a threaded portion 211 defined on the first end thereof and engaging with the cutter 14, a connected portion 212 formed from the second end thereof and coupling to the shaft 132 slideably, and an annular groove 213 formed on the second end thereof and adapted for receiving the clip 24 as to prevent the bearing from moving along the axle 21. In the preferred form, the profile of the connected portion 212 is non-circular, and the connected portion 212 has gaps on the distal end thereof.

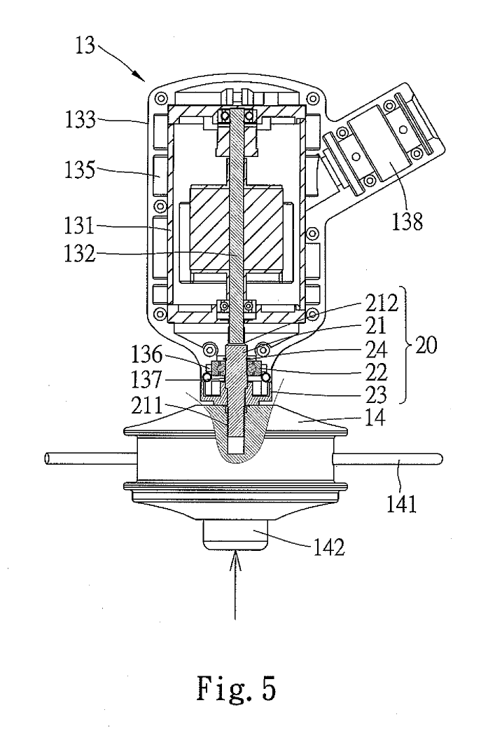

Referring to FIG. 5, when the user beats a button 142 of the cutter 14 for pulling the rope 141 outwardly, the axle 21 of the motor secure device 20 bears the axial force from the cutter 14 as to move axially. Next, the connected portion 212 slides relative to the end of the shaft 132 so that the shaft 132 does not directly bear the force when beating the cutter 14. Therefore, it retards to waste the shaft 132 and lengthen the use-life of the motor 131. Furthermore, the bearing 22, which is disposed on the axle 21 and directly bears the force exerted to the axle 21, so as to avoid the shaft 132 of the motor 131 to waste in mowing. Accordingly, it is more convenient to change a new shaft of the secure device 20 while the original shaft 22 is broken rather than fixing the motor 131 that is broken.

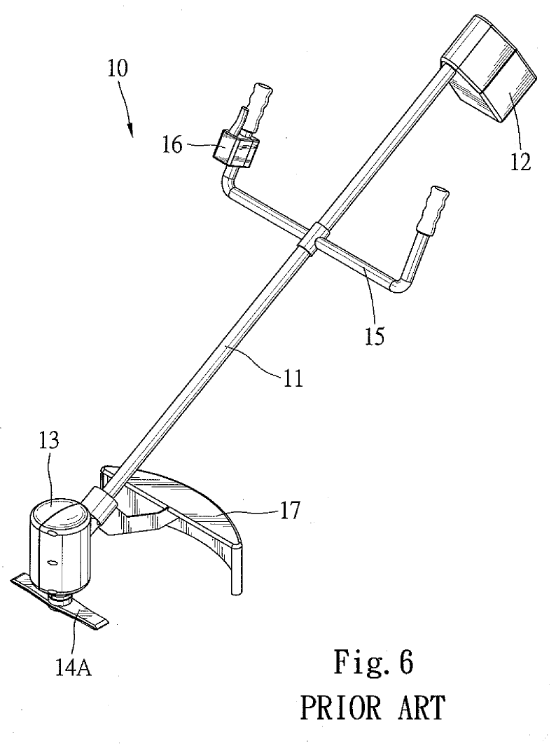

Referring to FIG. 6, it shows a second embodiment in the present invention similar to the first embodiment expect for a cutter 14A instead of the cutter 14. In the preferred form, the cutter 14A is a metal blade.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electric mowing machine comprising:
a stem;
a power supply disposed on the stem;
a motor base that is installed to the stem receiving a motor which electrically communicates with the power supply and includes a shaft disposed through the motor;
a cutter installed on the shaft of the motor rotatably; and
a motor secure device mounted between the cutter and the shaft of the motor and adapted for prevent the shaft of the motor from bearing external force.

2. The electric mowing machine as claimed in claim 1, wherein the motor secure device further comprising an axle adapted for connecting to the shaft of the motor and the cutter respectively, and a bearing mounted on the axle.

3. The electric mowing machine as claimed in claim 2, wherein the motor secure device further comprising an annular slot formed on the axle and a clip disposed in the slot.

4. The electric mowing machine as claimed in claim 1, wherein the motor base further comprising a compartment defined therein for receiving the motor, a through hole formed on an end thereof and communicating with the interior thereof, with the motor secure device inserted through the through hole for coupling to the shaft of the motor.

5. The electric mowing machine as claimed in claim 4, wherein the motor secure device further comprising a cap covering on the outer periphery of the through hole.

6. The electric mowing machine as claimed in claim 1, wherein the electric mowing machine further comprising a handle bar disposed on the stem.

7. The electric mowing machine as claimed in claim 6, wherein the electric mowing machine further comprising a power switch installed on the handle bar.

8. The electric mowing machine as claimed in claim 1, wherein the electric mowing machine further comprising a shield provided adjacent to a side of the motor base.

9. The electric mowing machine as claimed in claim 1, with the motor secure device connecting between the cutter and the shaft of the motor.

10. The electric mowing machine as claimed in claim 2, with the motor secure device connecting between the cutter and the shaft of the motor.

11. The electric mowing machine as claimed in claim 2, wherein the axle includes a connected portion for couples to the shaft; with the profile of the distal end of the shaft being non-circular, with the profile of the connected portion corresponding with that of the distal end of the shaft.

12. The electric mowing machine as claimed in claim 1, wherein the motor base consists of two halves, with each half complementarily receiving another half.
